(19) United States
(12) Patent Application Publication
(10) Pub. No.: US 2020/0193522 A1
(43) Pub. Date: Jun. 18, 2020

(54) SYSTEM AND METHOD PROVIDING AUTOMATED RISK ANALYSIS TOOL

(71) Applicants: Jonathan Brown, Glastonbury, CT (US); Edward A Flanders, JR., West Haven, CT (US); Lentz Merisier, Hartford, CT (US); Shashank Dilip Khot, Harrisburg, NC (US); Brian J. Scott, Manchester, CT (US); Briana Nicole Wolff, Southington, CT (US)

(72) Inventors: Jonathan Brown, Glastonbury, CT (US); Edward A Flanders, JR., West Haven, CT (US); Lentz Merisier, Hartford, CT (US); Shashank Dilip Khot, Harrisburg, NC (US); Brian J. Scott, Manchester, CT (US); Briana Nicole Wolff, Southington, CT (US)

(21) Appl. No.: 16/223,334

(22) Filed: Dec. 18, 2018

(51) Int. Cl. G06Q 40/08; G06F 9/451

(52) U.S. Cl. CPC G06Q 40/08; G06F 9/451

(57) ABSTRACT

A system to provide an automated risk analysis tool via a back-end application computer server of an enterprise may include an existing risk relationship data store containing electronic records that represent a plurality of existing risk relationships between the enterprise and a plurality of users (e.g., an electronic record identifier and a set of historic resource values associated with risk attributes). The system may receive an indication of a selected risk relationship between the enterprise and a selected entity and retrieve the electronic record associated with the selected risk relationship. The system can then receive an indication of a user selected revenue base for a most recent evaluation time period along with a user selectable normalization parameter. Historic resource values may be normalized based on the received user selectable normalization parameter and then be output to support an interactive display including entity risk information.

### BACKGROUND

It may be advantageous to analyze the risks associated with multiple systems and/or entities. For example, it might be advantageous to understand particular amounts of risk and the impact that such risks may have had on past (and, potentially, future) performance. Manually examining and understanding these types of risks, however, can be a complicated, time consuming, and error-prone task, especially when there are a substantial number of inter-related systems, entities, and/or other factors involved in the analysis.

It would be desirable to provide systems and methods to provide an automated risk analysis tool in a way that provides faster, more accurate results as compared to traditional approaches.

### SUMMARY OF THE INVENTION

According to some embodiments, systems, methods, apparatus, computer program code and means are provided to provide an automated risk analysis tool in a way that provides faster, more accurate results as compared to traditional approaches and that allow for flexibility and effectiveness when responding to those results. In some embodiments, a system may provide an automated risk analysis tool via a back-end application computer server of an enterprise. The system may include an existing risk relationship data store containing electronic records that represent a plurality of existing risk relationships between the enterprise and a plurality of users (e.g., an electronic record identifier and a set of historic resource values associated with risk attributes). The system may receive an indication of a selected risk relationship between the enterprise and a selected entity and retrieve the electronic record associated with the selected risk relationship. The system can then receive an indication of a user selected revenue base for a most recent evaluation time period along with a user selectable normalization parameter. Historic resource values may be normalized based on the received user selectable normalization parameter and then be output to support an interactive display including entity risk information.

Some embodiments comprise: means for receiving, at the back-end application computer server, an indication of a selected risk relationship between the enterprise and a selected entity; means for retrieving, by the back-end application computer server from the existing risk relationship data store, an electronic record associated with the selected risk relationship, including the set of historic resource values associated with risk attributes, wherein the existing risk relationship data store contains electronic records that represent a plurality of existing risk relationships between the enterprise and a plurality of users, and further wherein each electronic record includes an electronic record identifier and a set of historic resource values associated with risk attributes; means for receiving an indication of a user selected revenue base for a most recent evaluation time period; means for receiving a user selectable normalization parameter; means for normalizing historic resource values based on the received user selectable normalization parameter; means for outputting the normalized historic resource values via communication port; and means for facilitating a transmission of data with a remote device to support a graphical interactive user interface display via a distributed communication network, the interactive user interface display including entity risk information calculated based on the normalized historic resource values.

In some embodiments, a communication device associated with a back-end application computer server exchanges information with remote devices in connection with an interactive graphical user interface. The information may be exchanged, for example, via public and/or proprietary communication networks.

A technical effect of some embodiments of the invention is an improved and computerized way to provide an automated risk analysis tool in a way that provides faster, more accurate results as compared to traditional approaches. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of a system in accordance with some embodiments.

FIG. 2 illustrates a method according to some embodiments of the present invention.

FIG. 3 is an example of a dashboard setup display for an insurance policy update tool in accordance with some embodiments.

FIG. 4 is an example of a cover page display according to some embodiments.

FIG. 5 is an example of a scorecard display in accordance with some embodiments.

FIG. 6 is an example of a summary display according to some embodiments.

FIGS. 7 and 8 are examples of loss trend displays in accordance with some embodiments.

FIG. 9 is an example of a claim analysis display in accordance with some embodiments.

FIG. 10 is an example of a trend analysis display according to some embodiments.

FIG. 11 is an example of a financial detail display in accordance with some embodiments.

FIG. 12 is an example of a claim metric detail display according to some embodiments.

FIG. 13 is a more detailed high-level block diagram of a system in accordance with some embodiments.

FIG. 14 is another high-level block diagram of a system in accordance with some embodiments.

FIG. 15 illustrates a method according to some embodiments of the present invention.

FIG. 16 is a block diagram of an apparatus in accordance with some embodiments of the present invention.

FIG. 17 is a portion of a tabular risk relationship database according to some embodiments.

FIG. 18 is another high-level block diagram of a system in accordance with some embodiments.

FIG. 19 illustrates a tablet computer displaying a risk analysis tool user interface according to some embodiments.

FIG. 20 illustrates an overall process in accordance with some embodiments.

### DETAILED DESCRIPTION

The present invention provides significant technical improvements to facilitate electronic messaging and dynamic data processing. The present invention is directed to more than merely a computer implementation of a routine or conventional activity previously known in the industry as it significantly advances the technical efficiency, access, and/or accuracy of communications between devices by implementing a specific new method and system as defined herein. The present invention is a specific advancement in the area of electronic risk analysis and/or understanding by providing benefits in data accuracy, data availability, and data integrity and such advances are not merely a longstanding commercial practice. The present invention provides improvement beyond a mere generic computer implementation as it involves the processing and conversion of significant amounts of data in a new beneficial manner as well as the interaction of a variety of specialized client and/or third-party systems, networks, and subsystems. For example, in the present invention information may be processed, updated, and analyzed via back-end-end application server to accurately improve the analysis of risk and the exchange of information, thus improving the overall efficiency of the system associated with message storage requirements and/or bandwidth considerations (e.g., by reducing the number of messages that need to be transmitted via network). Moreover, embodiments associated with collecting accurate information might further improve risk values, predictions of risk values, allocations of resources, electronic record processing decisions, etc.

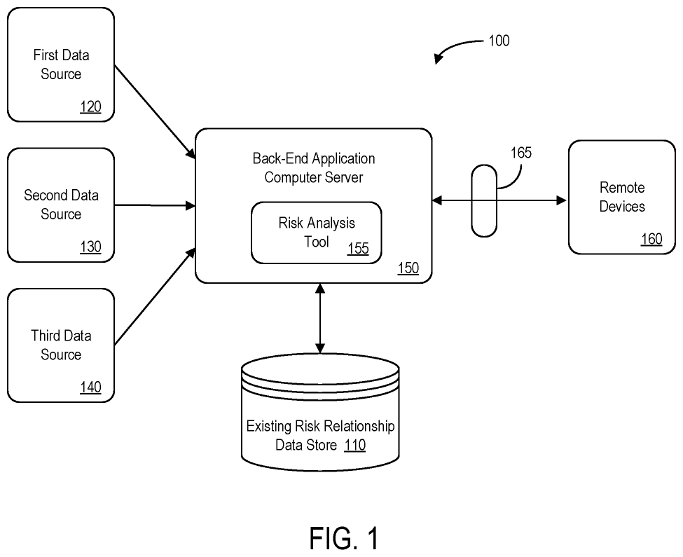

For example, FIG. 1 is a high-level block diagram of a system 100 according to some embodiments of the present invention. In particular, the system 100 includes a back-end application computer 150 server that may access information in an existing risk relationship data store 110 (e.g., storing a set of electronic records representing risk relationships or associations, each record including, for example, one or more risk relationship identifiers, attribute variables, resource values, etc.). The back-end application computer server 150 may also retrieve information from other data stores or sources 120, 130, 140 in connection with a risk analysis tool 155 and apply algorithms and/or models to the electronic records. The back-end application computer server 150 may also exchange information with a remote device 160 (e.g., via communication port 165 that might include a firewall). According to some embodiments, an interactive graphical user interface platform of the back-end application computer server 150 (and, in some cases, third-party data) may facilitate the display of information associated with the risk analysis tool 155 via one or more remote computers (e.g., to gather additional information about an existing risk relationship) and/or the remote device 160. For example, the remote device 160 may transmit updated information (e.g., a new normalization parameter) to the back-end application computer server 150. Based on the updated information, the back-end application computer server 150 may adjust data from the existing risk relationship data store 110 and automatically calculate and display updated values. Note that the back-end application computer server 150 and/or any of the other devices and methods described herein might be associated with a cloud-based environment and/or a third party, such as a vendor that performs a service for an enterprise.

The back-end application computer server 150 and/or the other elements of the system 100 might be, for example, associated with a Personal Computer (“PC”), laptop computer, smartphone, an enterprise server, a server farm, and/or a database or similar storage devices. According to some embodiments, an “automated” back-end application computer server 150 (and/or other elements of the system 100) may facilitate updates of electronic records in the existing risk relationship data store 110. As used herein, the term “automated” may refer to, for example, actions that can be performed with little (or no) intervention by a human.

As used herein, devices, including those associated with the back-end application computer server 150 and any other device described herein may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 150 may store information into and/or retrieve information from the existing risk relationship data store 110. The existing risk relationship data store 110 might, for example, store electronic records representing a plurality of existing risk associations, each electronic record having a set of attribute values including a resource value. The existing risk relationship data store 110 may also contain information about prior and current interactions with parties, including those associated with the remote devices 160. The existing risk relationship data store 110 may be locally stored or reside remote from the back-end application computer server 150. As will be described further below, the existing risk relationship data store 110 may be used by the back-end application computer server 150 in connection with an interactive user interface to provide information about the risk analysis tool 155. Although a single back-end application computer server 150 is shown in FIG. 1, any number of such devices may be included. Moreover, various devices described herein might be combined according to embodiments of the present invention. For example, in some embodiments, the back-end application computer server 150 and the existing risk relationship data store 110 might be co-located and/or may comprise a single apparatus.

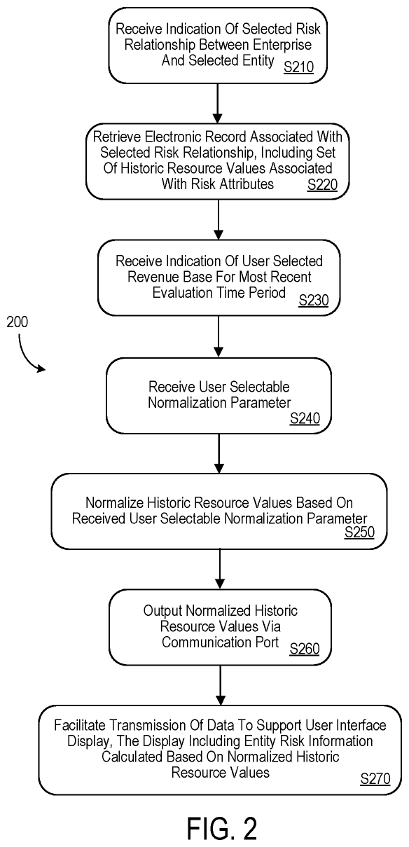

Note that the system 100 of FIG. 1 is provided only as an example, and embodiments may be associated with additional elements or components. According to some embodiments, the elements of the system 100 automatically transmit information associated with an interactive user interface display over a distributed communication network. FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, a back-end application computer server (e.g., associated with an enterprise) may receive an indication of a selected risk relationship between the enterprise and a selected entity. For example, an operator or administrator associated with the enterprise might select a risk relationship from a list of existing risk relationships.

At S220, the back-end application computer server may retrieve, from an existing risk relationship data store, an electronic record associated with the selected risk relationship. The electronic record might include, for example, a set of historic resource values associated with risk attributes. Note that the existing risk relationship data store might contain, according to some embodiments, electronic records that represent a plurality of existing risk relationships between the enterprise and a plurality of users. Moreover, each electronic might record include an electronic record identifier and a set of historic resource values associated with various risk attributes.

At S230, an indication of a user selected revenue base for a most recent evaluation time period may be received. For example, an operator or administrator associated with the enterprise might select particular months, years, etc. that should be evaluated and/or compared. At S240, a user selectable normalization parameter may be received. The user selectable normalization parameter might be associated with, for example, a number of employees, an amount of revenue, a quantity of product, etc.

At S250, the system may normalize historic resource values based on the received user selectable normalization parameter. According to some embodiments, the back-end application computer server may normalize the historic resource values and calculate risk information in accordance with a periodic batch process (e.g., a nightly batch process, a weekly batch process, etc.), in response to a request (e.g., a request from an operator, administrator, or customer), and/or in substantially real time (e.g., as the underlaying values change or are updated).

At S260, the system may output the normalized historic resource values via communication port (e.g., coupled to a communication network). At S270, the system may facilitate a transmission of data with a remote device to support a graphical interactive user interface display via the distributed communication network. The interactive user interface display might include, for example, entity risk information calculated based on the normalized historic resource values.

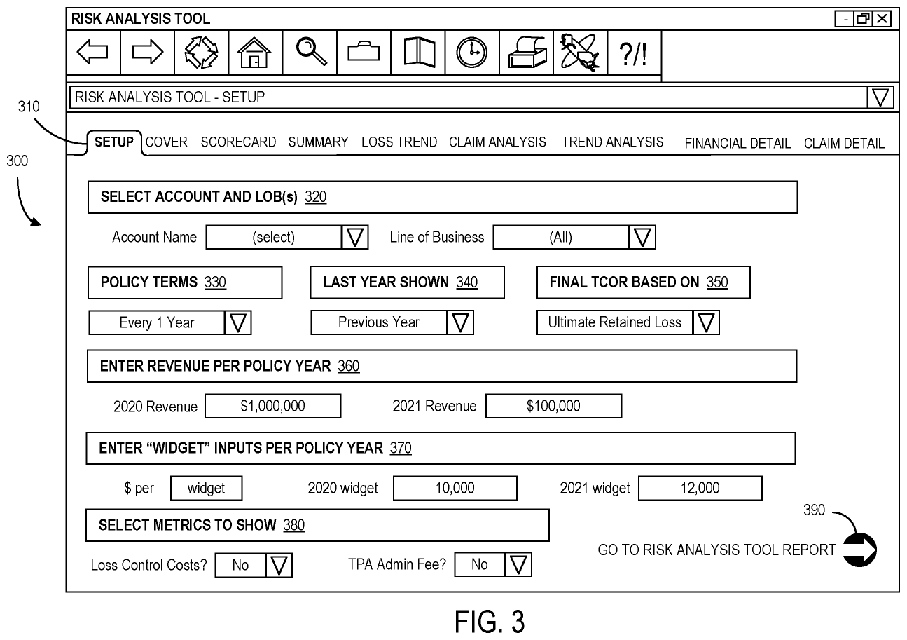

As explained in connection with FIGS. 3 through 20, according to some embodiments, the risk relationships represent insurance policies and at least one historic resource value is associated with a “total cost of risk” for the selected entity. As used herein, the phrase “total cost of risk” may refer to a total cost of insurance premiums, retained losses (deductibles/uninsured losses), and internal/external risk control costs associated with an enterprise. Factors that might impact a total cost of interest include insurance premiums, brokerage fees, retained losses (e.g., an amount spent “out of pocket” for incurred loses, costs to protect employees and/or customers from injury (e.g., safety equipment, training, etc.), costs to engage others in connection with risk and insurance issues, productivity losses, etc.

According to some embodiments, an interactive user interface display may include a dashboard setup user interface that provides an entity identifier and sub-relationship selection. FIG. 3 is an example of a dashboard setup display 300 for an insurance policy update tool in accordance with some embodiments. The dashboard setup display 300 might be used, for example, by an operator or administrator to configure a total cost of risk tool for use by an insured (e.g., a Chief Financial Officer (“CFO”) or risk manager associated with an enterprise). The display 300 includes a tabular navigation selection area 310 where a user can select a “Setup” tab to view the display 300. The display 300 includes an account and Line of Business (“LOB”) selection area 320 where the user can select an account name (e.g., an insured identifier) and LOB to be analyzed. As used herein, the LOB might be associated with a sub-relationship between an insured and an insurer, such as insurance, workers' compensation insurance, etc.

The dashboard setup display 300 may further include a relationship term selection (e.g., policy terms 330), relationship year selection (e.g., last year shown 340), and a final risk value selection (e.g., upon which the final Total Cost Of Risk (“TCOR”) is based 350). The display 300 may also include a resources per term selection (e.g., revenue per policy year 360) and normalization parameter selections (e.g., “Widget” inputs per policy year 370). According to some embodiments, the display 300 may further include a metric inclusion selection (e.g., metrics to show 380 such as loss control costs, Third Party Administrator (“TPA”) fees, etc.). The display 300 might also include one or more additional instruction links, training material links, resource links, etc.

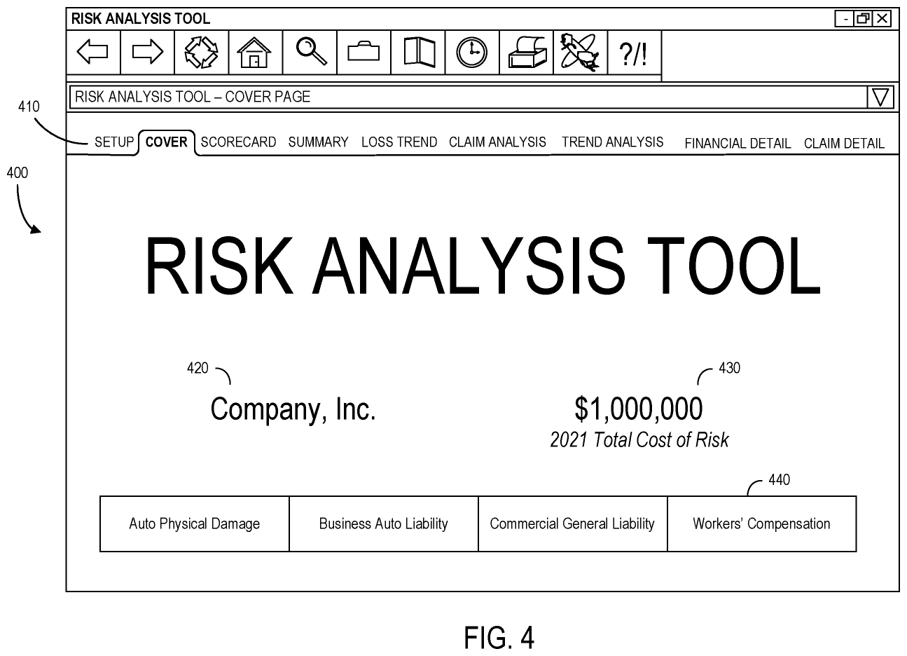

According to some embodiments, the dashboard setup display 300 also includes a “Go to Risk Analysis Tool Report” icon 390 that, when selected, lead to other interfaces associated with the risk analysis tool. For example, selection of icon 390 might result in a cover page display 400 as illustrated in FIG. 4 according to some embodiments. The display 400 includes a tabular navigation selection area 410 where a user can select a “Cover” tab to view the cove page display 400. The display 400 may include an insured identifier 420 and an overall total cost of risk amount 430. According to some embodiments, the display 400 further includes a LOB area 440 (e.g., associated with automobile physical damage, business automobile liability, commercial general liability, workers' compensation, etc.).

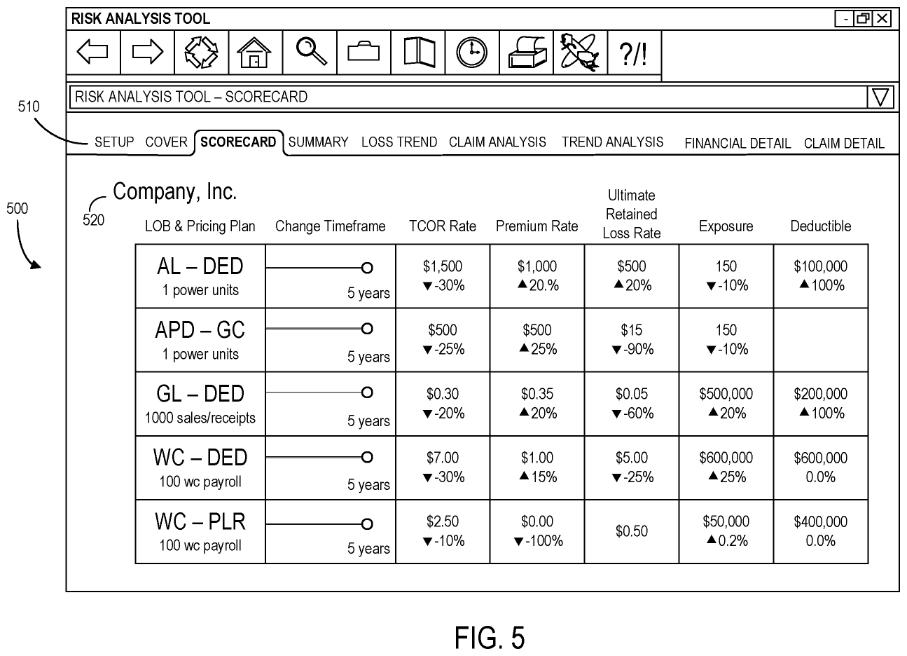

In some embodiments, the interactive user interface display includes a scorecard user interface providing an entity identifier along with attribute values arranged by sub-relationships. For example, FIG. 5 is an example of a scorecard display 500 in accordance with some embodiments. The display 500 includes a tabular navigation selection area 510 where a user can select a “Scorecard” tab to view the scorecard display 500. The display 500 includes an insured identifier 520 and summary values arranged by LOB and pricing plans, such as: Automobile Liability (“AL”) insurance and a Deductible (“DED”) program; Automobile Physical Damage (“APD”) insurance and a Guaranteed Cost (“GC”) program; General Liability (“GL”) and a DED program; Workers' Compensation (“WC”) and a DED program; and WC and a Paid Loss Retrospective (“PLR”) program. The summary values for each line of business on the display 500 might include, for example: a change timeframe; a TCOR rate, a premium rate, an ultimate retained loss rate, exposure, a deductible amount, etc.

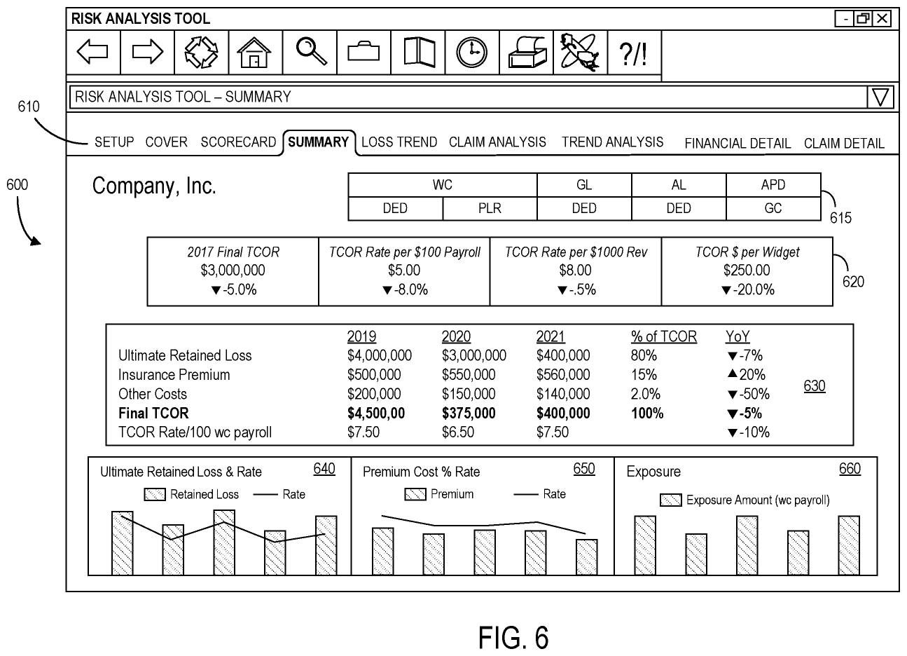

According to some embodiments, the interactive user interface display includes a summary user interface that provides a sub-relationship selection portion. For example, FIG. 6 is an example of a summary display 600 according to some embodiments. The display 600 includes a tabular navigation selection area 610 where a user can select a “Summary” tab to view the summary display 600 and a sub-relationship selection portion 615 (e.g., containing user-selectable areas for WC, GL, AL, etc.). The display 600 may also include entity risk information calculated based on the normalized historic resource values 620 (e.g., a final TCOR, a TCOR rate per $100 of payroll, a TCOR rate per $1,000 of revenue, a TCOR dollar amount per “widget,” etc.). The display 600 may also include entity risk information 630 associated with multiple time periods (e.g., the TCOR details such as ultimate retained loss, insurance premium, other costs, a final TCOR, and a TCOR rate per 100 WC payroll employees).

The summary display 600 may also include a number of graphical representations of TCOR related data. For example, the display 600 might include an ultimate retained loss and rate graph 640 (e.g., over a period of time), a premium cost and rate 650 (e.g., over a period of time), an exposure graph 660 (e.g., based on WC payroll), etc. Note that the graphs 640, 650, 660 (and any of the other graphs described herein) might further include axis labels (e.g., with time periods on the x-axis and dollar amounts on the y-axis). Moreover, the graphs 640, 650, 660 (and any of the other graphs described herein) might further include textual description of various data points. Selection of an item in the sub-relationship selection portion 615 (e.g., a particular LOB and or related program) may result in the graphs 640, 650, 660 being updated accordingly (and a similar mechanic might apply to any of the other displays described herein).

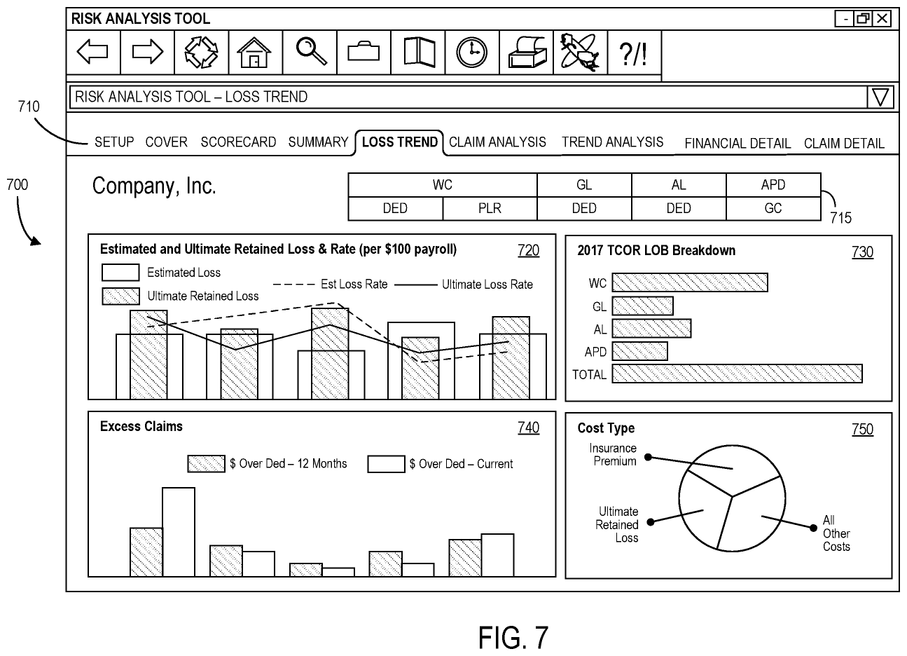

According to some embodiments, the interactive user interface display includes a loss trend user interface that provides risk detail information based on sub-relationships. For example, FIG. 7 is an example of a loss trend display 700 in accordance with some embodiments. The display 700 includes a tabular navigation selection area 710 where a user can select a “Loss Trend” tab to view the loss trend display 700 and a sub-relationship selection portion 715 (e.g., containing user-selectable areas for WC, GL, AL, etc.). According to some embodiments, the display 700 also includes estimated and ultimate retained loss and rate information 720 (e.g., including estimated loss pick, ultimate retained loss including above and below estimate data, an estimated loss rate, an ultimate loss rate, etc.). According to some embodiments, the information 720 includes an ultimate retained loss bar chart (illustrated with crosshatching in FIG. 7) superimposed over an estimated loss pick bar chart (illustrated without crosshatching in FIG. 7) to help a user better understand any discrepancies. The display 700 might further include a TCOR LOB breakdown 730, excess claim data 740, a breakdown of cost types 750, etc.

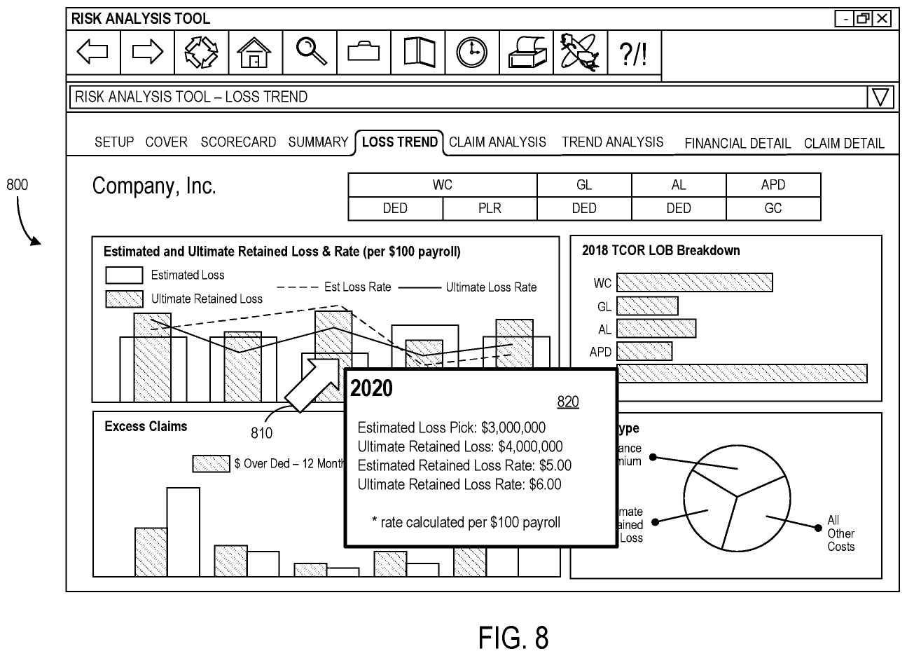

Note that selection of a graphical element on any of the interactive user interface displays described herein might result in further details about that element being displayed via pop-up window, an ability to adjust information associated with that element, etc. For example, FIG. 8 is an example of a trend loss display 800 similar to the one described with respect to FIG. 7 according to some embodiments. Selection of a graphical element on the display 800 (e.g., selecting a particular bar in a graph via touchscreen, computer mouse pointer 810 or any other method) might result in a pop-up window 820 that provides additional data, such as detailed values underlying or supporting the graph that was associated with the selected element (and, in some cases, might let the user alter or update information about the selected element).

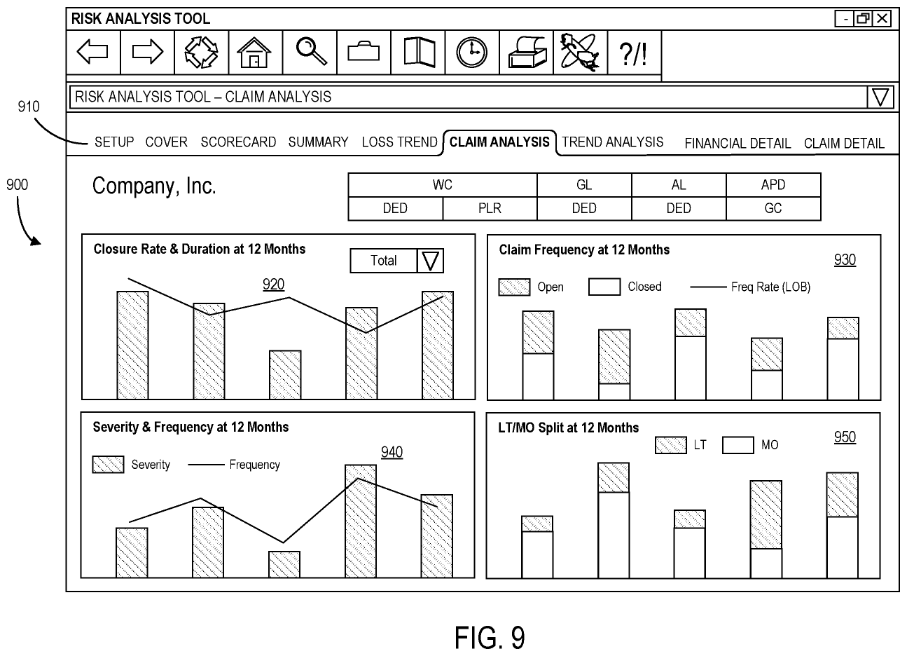

According to some embodiments, the interactive user interface display includes a claim analysis user interface that provides risk frequency information over time. For example, FIG. 9 is an example of a claim analysis display 900 in accordance with some embodiments. The display 900 includes a tabular navigation selection area 910 where a user can select a “Claim Analysis” tab to view the claim analysis display 900 along with risk frequency information such as closure rate and duration 920 over a particular period of time (e.g., 12 months) and insurance claim frequency information 930. According to some embodiments, the display 900 also provides risk severity information over time (e.g., a severity and frequency graph 940) and resource split data over time (e.g., a graph 950 breaking down Lost Time (“LT”) and Medical Only (“MO”) expenses over various time periods).

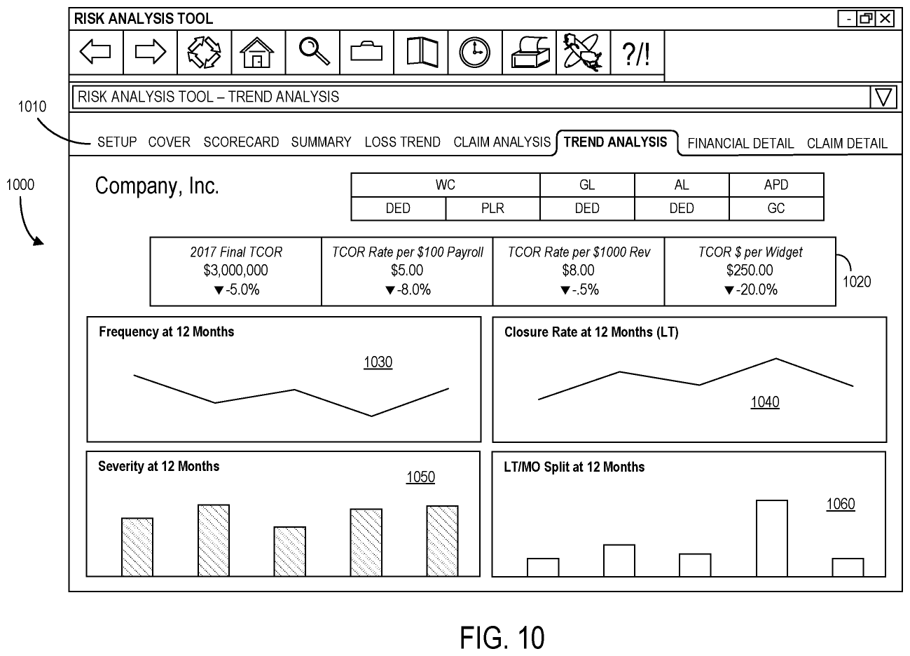

In some embodiments, the interactive user interface display includes a trend analysis user interface that provides frequency trend information. For example, FIG. 10 is an example of a trend analysis display 1000 according to some embodiments. The display 1000 includes a tabular navigation selection area 1010 where a user can select a “Trend Analysis” tab to view the trend analysis display 1000 along with entity risk information calculated based on the normalized historic resource values 1020 (e.g., a final TCOR, a TCOR rate per $100 of payroll, a TCOR rate per $1,000 of revenue, a TCOR dollar amount per “widget,” etc.). The trend analysis display 1000 may also include a frequency graph 1030, closure trend information (e.g. a closure rate graph 1040), severity trend information (e.g., a severity graph 1050), and/or duration trend information (e.g., an insurance claim duration graph 1060).

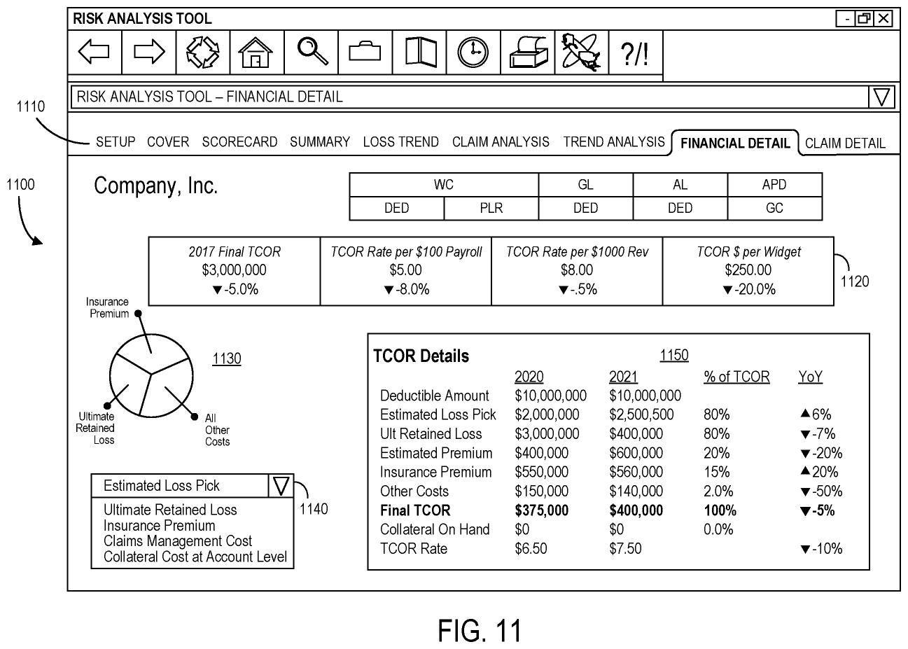

According to some embodiments, the interactive user interface display includes a financial detail user interface that provides risk resource breakdown information. For example, FIG. 11 is an example of a financial detail display 1100 in accordance with some embodiments. The display 1100 includes a tabular navigation selection area 1110 where a user can select a “Financial Detail” tab to view the financial detail display 1100 along with entity risk information calculated based on the normalized historic resource values 1120. The risk resource breakdown information on the display 1100 might include a TCOR breakdown 1130 and a user selectable customization 1140, such as by estimated loss pick, ultimate retained loss, insurance premium, claims management cost, collateral cost at account level, loss deposit, post program adjustments, a final TCOR, etc. The financial detail display 1100 may also provide detailed risk data over time for multiple risk attributes (e.g., TCOR details 1150), such as a deductible amount, an estimated loss pick, an ultimate retained loss, an estimated premium, a claims management cost, an estimated collateral cost at an account level, a loss deposit, a TCOR subtotal, post program adjustments, a final TCOR, collateral on hand, a TCOR rate per 100 WC employees on the payroll, etc.

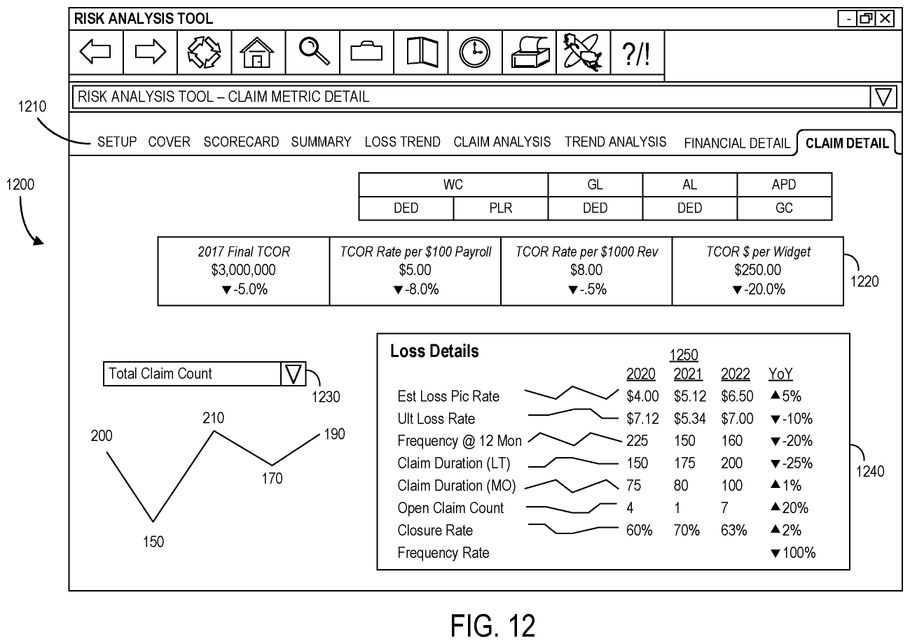

In some embodiments, the interactive user interface display includes a claim metric detail user interface that provides resource loss details over time for multiple risk attributes. For example, FIG. 12 is an example of a claim metric detail display 1200 according to some embodiments. The display 1200 includes a tabular navigation selection area 1210 where a user can select a “Claim Detail” tab to view the claim metric detail display 1200 along with entity risk information calculated based on the normalized historic resource values 1220. According to some embodiments, the display 1200 may include a total event count over time (e.g., a user-selectable graph 1230 showing a total insurance claim count or other types of information). The display 1200 might also provide loss details 1240 including a graphical representation of resource loss details over time for multiple risk attributes such as an estimated loss pick per $1,000 of payroll costs (or any other dollar amount), an ultimate loss rate per $100 of payroll costs, a frequency at 12 months (or any other period of time), a claim duration at 12 months for lost time, a claim duration at 12 months for medical only costs, an open claim count, a closure rate (for lost time or medical only costs), a frequency rate, a severity, a percentage of lost time claims, a top ten claims, a total incurred retained value, a total claim count, etc.

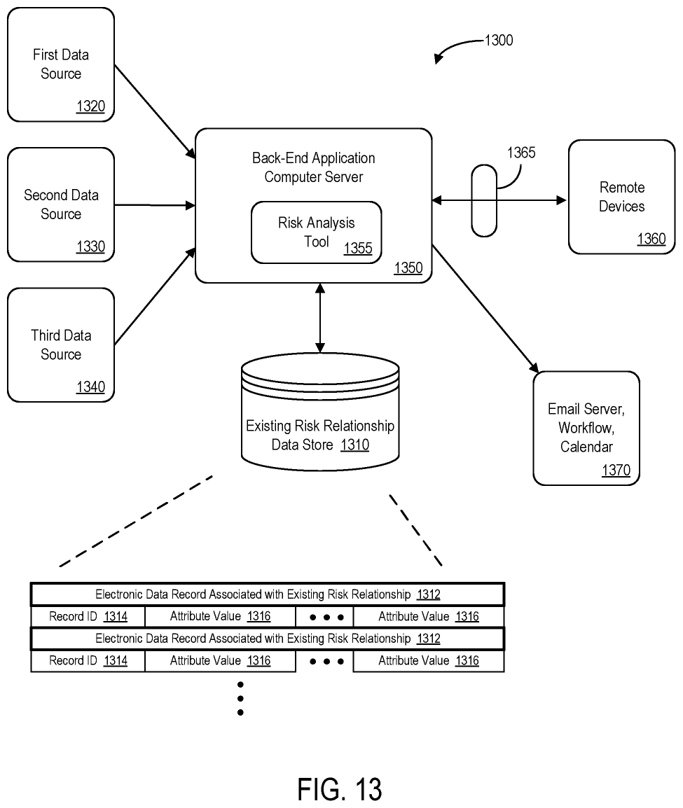

FIG. 13 is a more detailed high-level block diagram of a system 1300 in accordance with some embodiments. As before, the system 1300 includes a back-end application computer 1350 server that may access information in an existing risk relationship data store 1310. The existing risk relationship data store 1310 might include, for example, a set of electronic records 1312 representing risk relationships or associations, each record 1312 including, for example, one or more risk relationship identifiers 1314, attribute values 1316, resource values (e.g., dollar amounts), etc. The back-end application computer server 1350 may also retrieve information from other data stores or sources 1320, 1330, 1340 in connection with a risk analysis tool 1355 and apply algorithms and/or models to the electronic records 1312. The back-end application computer server 1350 may also exchange information with a remote device 1360 (e.g., via communication port 1365).

According to some embodiments, an interactive graphical user interface platform of the back-end application computer server 1350 (and, in some cases, third-party data) may facilitate the display of information associated with the risk analysis tool 1355 via one or more remote computers (e.g., to gather additional information about an existing risk relationship) and/or the remote device 1360. For example, the remote device 1360 may transmit updated information (e.g., a new normalization parameter) to the back-end application computer server 1350. Based on the updated information, the back-end application computer server 1350 may adjust data from the existing risk relationship data store 1310 and automatically calculate and display updated values. The back-end application computer server 1350 might also exchange information with business servers 1370, such as an email server (e.g., to transmit information about TCOR), a workflow server (e.g., to initiate a business process), a calendar server (e.g., to schedule an event or reminder), etc.

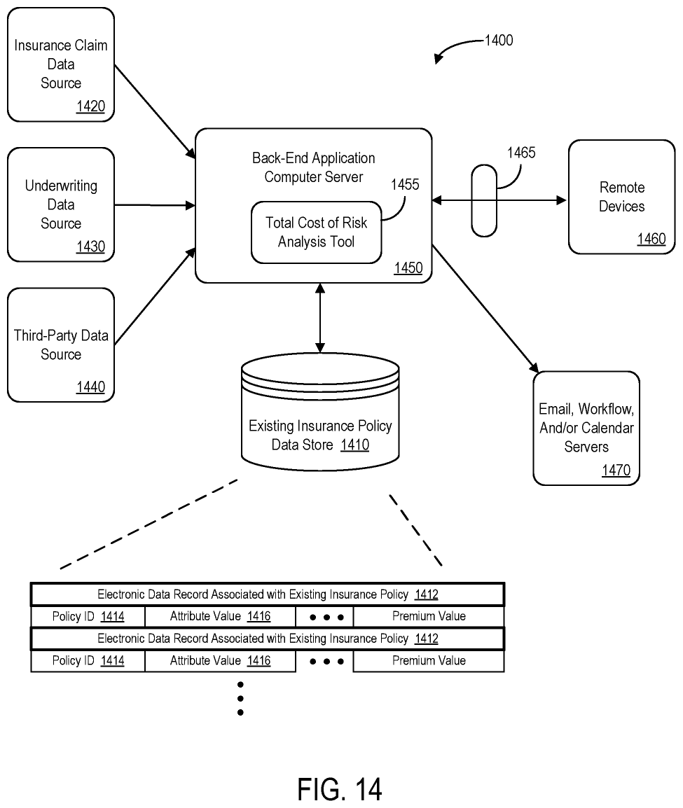

According to some embodiments, a risk analysis tool might be associated with a total cost of risk associated with one or more insurance policies. For example, FIG. 14 is another high-level block diagram of an insurance enterprise system 1400 in accordance with some embodiments. As before, the system 1400 includes a back-end application computer 1450 server that may access information in an existing insurance policy data store 1410. The existing insurance policy data store 1410 might include, for example, a set of electronic records 1412 representing insurance policies, each record 1412 including, for example, one or more insurance policy identifiers 1414, attribute values 1416, premium values (e.g., dollar amounts), etc. The back-end application computer server 1450 may also retrieve information from other data sources such as an insurance claim data source 1420, an underwriting data source 1430, a third-party data source 1440, etc. in connection with a total cost of risk analysis tool 1455 and apply algorithms and/or models to the electronic records 1412. The back-end application computer server 1450 may also exchange information with a remote device 1460 (e.g., via communication port 1465) associated with an operator, administrator, or insured.

According to some embodiments, an interactive graphical user interface platform of the back-end application computer server 1450 (and, in some cases, information from the third-party data source 1440) may facilitate the display of information associated with the total cost of risk analysis tool 1455 via one or more remote computers (e.g., to gather information about adjustments to an existing insurance policy) and/or the remote device 1460. For example, the remote device 1460 may transmit updated information (e.g., a new policy year for analysis) to the back-end application computer server 1450. Based on the updated information, the back-end application computer server 1450 may adjust data from the existing insurance policy data store 1410 and automatically calculate and display updated values. The back-end application computer server 1450 might also exchange information with insurance servers 1470, such as an email server (e.g., to transmit information about an existing or new insurance policy), a workflow server (e.g., to initiate a new insurance process), a calendar server (e.g., to schedule an insurance audit or review), etc.

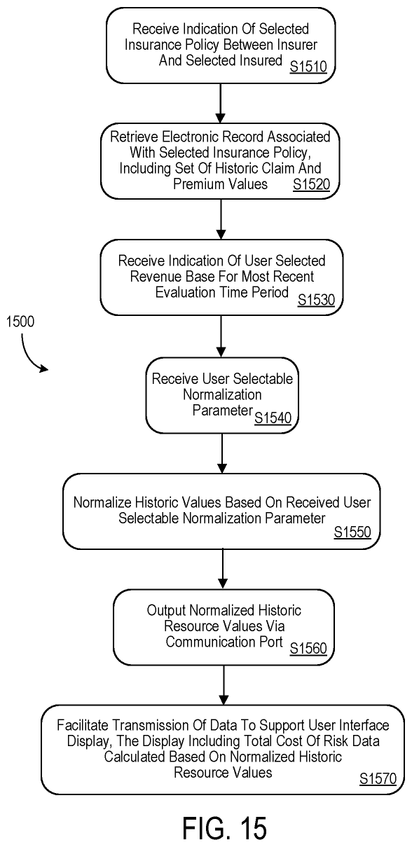

FIG. 15 illustrates a method 1500 according to some embodiments of the present invention. At S1510, a back-end application computer server (e.g., associated with an insurer) may receive an indication of a selected insurance between the insurer and a selected insured. For example, an operator or administrator associated with the insurer might select an insurance from a list of existing insurance policies. At S1520, the back-end application computer server may retrieve, from an existing insurance policy data store, an electronic record associated with the selected insurance policy. The electronic record might include, for example, a set of historic claim and premium values. Note that the existing insurance policy data store might contain, according to some embodiments, electronic records that represent a plurality of existing insurance policies between the insurer and a plurality of insureds. At S1530, an indication of a user selected revenue base for a most recent evaluation time period may be received. For example, an operator or administrator associated with the insurer might select particular policy periods that should be evaluated and/or compared. At S1540, a user selectable normalization parameter may be received. The user selectable normalization parameter might be associated with, for example, a number of employees, an amount of revenue, a quantity of product, etc.

At S1550, the system may normalize historic resource values based on the received user selectable normalization parameter. According to some embodiments, the back-end application computer server may normalize the historic resource values and calculate risk information in accordance with a periodic batch process (e.g., a nightly batch process, a weekly batch process, etc.), in response to a request (e.g., a request from an operator, administrator, or customer), and/or in substantially real time (e.g., as the underlaying values change or are updated). At S1560, the system may output the normalized historic resource values via communication port (e.g., coupled to a communication network). At S1570, the system may facilitate a transmission of data with a remote device to support a graphical interactive user interface display via the distributed communication network. The interactive user interface display might include, for example, total cost of risk information calculated based on the normalized historic resource values.

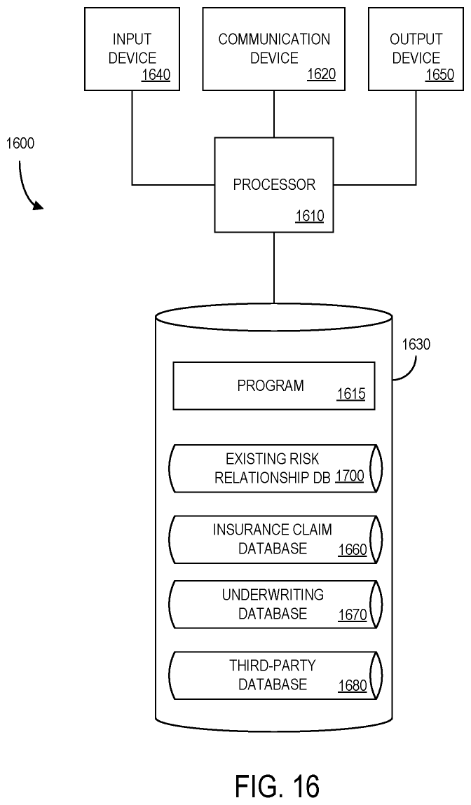

The embodiments described herein may be implemented using any number of different hardware configurations. For example, FIG. 16 illustrates an apparatus 1600 that may be, for example, associated with the systems 100, 1400 described with respect to FIGS. 1 and 14, respectively. The apparatus 1600 comprises a processor 1610, such as one or more commercially available Central Processing Units (“CPUs”) in the form of one-chip microprocessors, coupled to a communication device 1620 configured to communicate via communication network (not shown in FIG. 16). The communication device 1620 may be used to communicate, for example, with one or more remote administrator computers and or communication devices (e.g., PCs and smartphones). Note that communications exchanged via the communication device 1620 may utilize security features, such as those between a public internet user and an internal network of the insurance enterprise. The security features might be associated with, for example, web servers, firewalls, and/or PCI infrastructure. The apparatus 1600 further includes an input device 1640 (e.g., a mouse and/or keyboard to enter information about an insured, evaluation periods, normalization parameters, etc.) and an output device 1650 (e.g., to output reports regarding insurance total cost of risk).

The processor 1610 also communicates with a storage device 1630. The storage device 1630 may comprise any appropriate information storage device, including combinations of magnetic storage devices (e.g., a hard disk drive), optical storage devices, mobile telephones, and/or semiconductor memory devices. The storage device 1630 stores a program 1615 and/or a risk analysis tool or application for controlling the processor 1610. The processor 1610 performs instructions of the program 1615, and thereby operates in accordance with any of the embodiments described herein. For example, the processor 1610 may receive an indication of a selected risk relationship between an enterprise and a selected entity and retrieve an electronic record associated with the selected risk relationship. The processor 1610 can then receive an indication of a user selected revenue base for a most recent evaluation time period along with a user selectable normalization parameter. Historic resource values may be normalized by the processor 1610 based on the received user selectable normalization parameter and then output to support an interactive display.

The program 1615 may be stored in a compressed, uncompiled and/or encrypted format. The program 1615 may furthermore include other program elements, such as an operating system, a database management system, and/or device drivers used by the processor 1610 to interface with peripheral devices.

As used herein, information may be “received” by or “transmitted” to, for example: (i) the back-end application computer server 1600 from another device; or (ii) a software application or module within the back-end application computer server 1600 from another software application, module, or any other source.

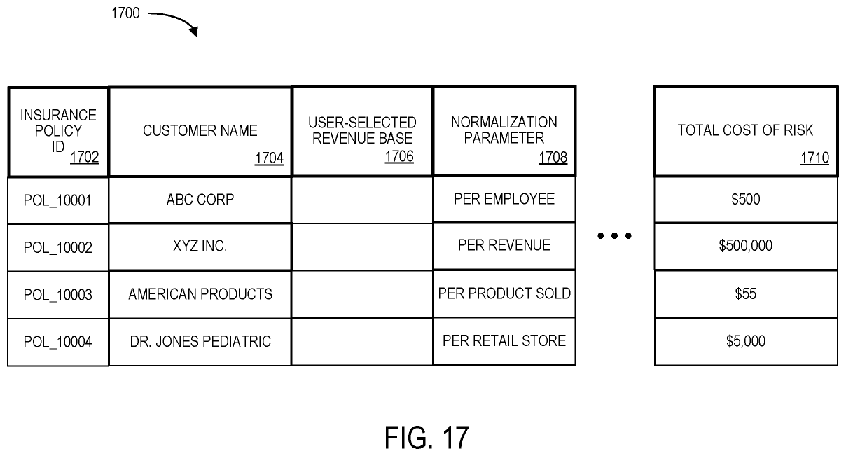

In some embodiments (such as shown in FIG. 16), the storage device 1630 further stores the existing risk relationship database 1700, an insurance claim database 1660, an underwriting database 1670, and a third-party database 1680. An example of a database that might be used in connection with the apparatus 1600 will now be described in detail with respect to FIG. 17. Note that the database described herein is only an example, and additional and/or different information may be stored therein. Moreover, various databases might be split or combined in accordance with any of the embodiments described herein. For example, the existing risk relationship database 1700 and the insurance claim database 1660 might be combined and/or linked to each other within the program 1615.

Referring to FIG. 17, a table is shown that represents the existing risk relation database 1700 that may be stored at the apparatus 1700 according to some embodiments. The table may include, for example, entries associated with insurance policies for which a risk analysis may be performed. The table may also define fields 1702, 1704, 1706, 1708, 1710 for each of the entries. The fields 1702, 1704, 1706, 1708, 1710 may, according to some embodiments, specify: an insurance policy identifier 1702, a customer name 1704, user selected revenue base 1706, a normalization parameter 1708, and total cost of risk 1710. The existing risk relation database 1700 may be created and updated, for example, based on information electrically received from various operators, administrators, and computer systems, including those associated with an insurer.

The insurance policy identifier 1702 may be, for example, a unique alphanumeric code identifying an insurance policy that needs to have a risk analysis performed (e.g., to help explain potential cost savings to an insured). The customer name 1704 may be associated with the insured. The user selected revenue base 1706 may be associated with a most recent evaluation time period, and the normalization parameter 1708 may be used to customize the analysis. The information in the existing risk relationship database 1700 may then be used to generate total cost of risk 1710 information that can be transmitted to the customer via a dashboard display.

Thus, embodiments may provide an automated and efficient way to provide an automated risk analysis tool in a way that provides faster, more accurate results as compared to traditional approaches. Embodiments may be used to explain potential cost savings to an existing (or potential new) customer. For example, an insurer might have value added services that could be provided to improve an insured's overall total cost of risk.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to particular types of insurance policies, embodiments may instead be associated with other types of insurance policies in additional to and/or instead of the policies described herein (e.g., professional liability insurance policies, extreme weather insurance policies, etc.). Similarly, although certain attributes (e.g., values analyzed in connection with a total cost of risk) were described in connection some embodiments herein, other types of attributes might be used instead.

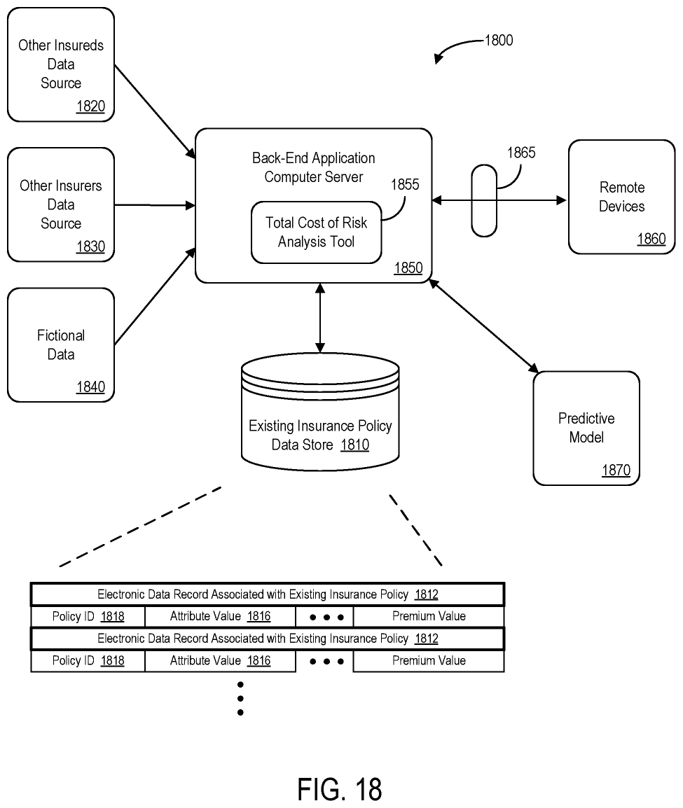

Moreover, addition information and/or functionality might be provided in accordance with any of the embodiments described herein. For example, FIG. 18 is another high-level block diagram of a system in accordance with some embodiments. As before, the system 1800 includes a back-end application computer 1850 server that may access information in an existing insurance policy data store 1810. The existing insurance policy data store 1810 might include, for example, a set of electronic records 1812 representing insurance policies, each record 1812 including, for example, one or more insurance policy identifiers 1814, attribute values 1816, premium values (e.g., dollar amounts), etc. The back-end application computer server 1850 may also retrieve information from other data sources. For example, the system 1800 may receive information from an other insured data source 1820 to benchmark risk information against other entities (e.g., “your total cost of risk is 20% lower as compared to similar sized companies in the same industry”). The system 1800 may also receive information from an other insurers data source 1830 to benchmark risk information against other enterprises (e.g., to let the dashboard display include other types of insurance offered by other insurers) and/or fictional data 1840 (e.g., to provide a “mocked up” report to a potential new client). The back-end application computer server 1850 may also exchange information with a remote device 1860 (e.g., via communication port 1865) associated with an operator, administrator, or insured.

According to some embodiments, an interactive graphical user interface platform of the back-end application computer server 1850 may facilitate the display of information associated with the total cost of risk analysis tool 1855 via one or more remote computers (e.g., to gather information about adjustments to an existing insurance policy) and/or the remote device 1860. For example, the remote device 1860 may transmit updated information (e.g., a new policy year for analysis) to the back-end application computer server 1850. Based on the updated information, the back-end application computer server 1850 may adjust data from the existing insurance policy data store 1810 and automatically calculate and display updated values. The back-end application computer server 1850 might also exchange information with a predictive model so that the insurer can adjust a predictive model 1870 associated with the total cost of risk (e.g., to improve the model's ability to predict future costs). According to some embodiments, the system may also arrange for a user associated with an entity (e.g., a client CFO) to logon and access the interactive user interface display. For example, the system 1800 might let the user modify the interactive user interface display (e.g., to customize various templates available in a library), add potential sub-relationships to the interactive user interface display (e.g., how would TCOR change if WC was added to an existing insurance package), and/or add relationships with other enterprises to the interactive user interface (e.g., to allow the user to see the complete picture of the enterprise total cost of risk).

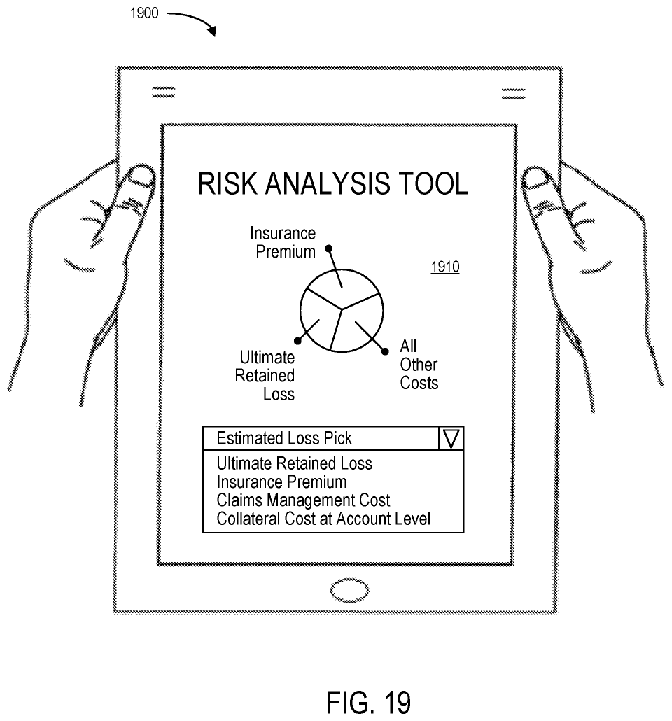

Still further, the displays and devices illustrated herein are only provided as examples, and embodiments may be associated with any other types of user interfaces. For example, FIG. 19 illustrates a handheld tablet computer 1900 showing a risk analysis tool display 1910 according to some embodiments. The risk analysis tool display 1910 might include user-selectable data that can be selected and/or modified by a user of the handheld computer 1900 to provide information about insurance total cost of risk.

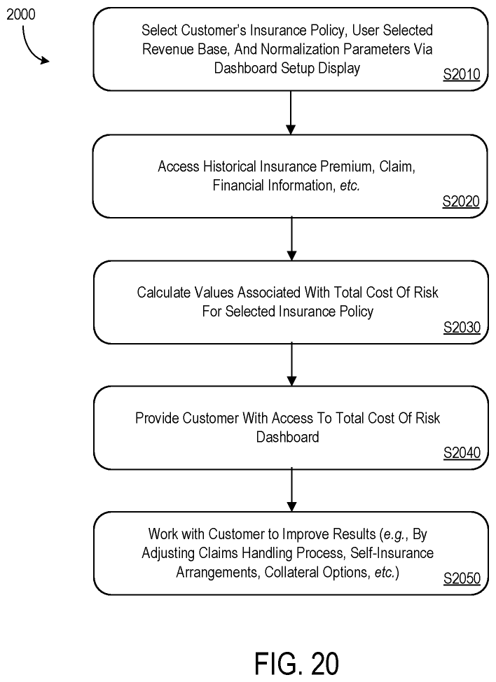

FIG. 20 illustrates an overall business process 2000 in accordance with some embodiments. At S2010, an insurer might select a customer's insurance policy, a user selected revenue base, and/or normalization parameters via dashboard setup display. The system may then access historical insurance premium, claim, financial information, etc. at S2020 in accordance with those selections and calculate values associated with total cost of risk for selected insurance policy at S2030. At S2040, the system may provide the customer with access to a total cost of risk dashboard. At S2050, the insurer might work with the customer (e.g., a risk engineer) to improve the total cost of risk results (e.g., by adjusting a claims handling process, self-insurance arrangements, collateral options, etc.).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system to provide an automated risk analysis tool via a back-end application computer server of an enterprise, comprising:
(a) an existing risk relationship data store containing electronic records that represent a plurality of existing risk relationships between the enterprise and a plurality of users, wherein each electronic record includes an electronic record identifier and a set of historic resource values associated with risk attributes;
(b) the back-end application computer server, coupled to the existing risk relationship data store, programmed to:
(i) receive an indication of a selected risk relationship between the enterprise and a selected entity,
(ii) retrieve, from the existing risk relationship data store, the electronic record associated with the selected risk relationship, including the set of historic resource values associated with risk attributes,
(iii) receive an indication of a user selected revenue base for a most recent evaluation time period,
(iv) receive a user selectable normalization parameter,
(v) normalize historic resource values based on the received user selectable normalization parameter, and
(vi) output the normalized historic resource values; and
(c) a communication port coupled to the back-end application computer server to facilitate a transmission of data with a remote device to support a graphical interactive user interface display via a distributed communication network, the interactive user interface display including entity risk information calculated based on the normalized historic resource values.

2. The system of claim 1, wherein the interactive user interface display includes a dashboard setup user interface providing at least one of: (i) entity identifier and sub-relationship selection, (ii) relationship term selection, (iii) relationship year selection, (iv) final risk value selection, (v) resources per term selection, (vi) normalization parameter selections, (vii) metric inclusion selection, (viii) an additional instructions link, (ix) a training material link, and (x) a resources link.

3. The system of claim 1, wherein the interactive user interface display includes a scorecard user interface providing at least one of: (i) an entity identifier, and (ii) attribute values arranged by sub-relationships.

4. The system of claim 1, wherein the interactive user interface display includes a summary user interface providing at least one of: (i) a sub-relationship selection portion, (ii) entity risk information calculated based on the normalized historic resource values, and (iii) entity risk information associated with multiple time periods.

5. The system of claim 1, wherein the interactive user interface display includes a loss trend user interface providing at least one of: (i) risk detail information based on sub-relationships, (ii) a breakdown of resource types, and (iii) above estimated risk data over time along with below estimated risk data over time.

6. The system of claim 1, wherein the interactive user interface display includes a claim analysis user interface providing at least one of: (i) risk frequency information over time, (ii) risk severity information over time, and (iii) resource split data over time.

7. The system of claim 1, wherein the interactive user interface display includes a trend analysis user interface providing at least one of: (i) frequency trend information, (ii) closure trend information, (iii) severity trend information, and (iv) duration trend information.

8. The system of claim 1, wherein the interactive user interface display includes a financial detail user interface providing at least one of: (i) risk resource breakdown information, and (ii) detailed risk data over time for multiple risk attributes.

9. The system of claim 1, wherein the interactive user interface display includes a claim metric detail user interface providing at least one of: (i) resource loss details over time for multiple risk attributes, (ii) a total event count over time, and (iii) a graphical representation of the resource loss details over time for multiple risk attributes.

10. The system of claim 1, wherein the risk relationships are associated with insurance policies and at least one historic resource value comprises a total cost of risk for the selected entity.

11. The system of claim 10, wherein the user selectable normalization parameter is associated with at least one of: (i) a number of employees, (ii) an amount of revenue, and (iii) a quantity of product.

12. The system of claim 10, wherein at least one sub-relationship is associated with at least one of: (i) automotive liability insurance, (ii) auto physical damage insurance, (iii) general liability insurance, (iv) workers' compensation insurance, (v) a deductible program, (vi) a paid loss retrospective program, and (vii) a guaranteed cost program.

13. The system of claim 10, wherein the risk analysis tool is associated with a total cost of risk analysis of the insurance policy.

14. The system of claim 1, wherein selection of a graphical element on the interactive user interface display results in at least one of: (i) further details about that element being displayed via pop-up window, and (ii) an ability to adjust information associated with that element.

15. The system of claim 1, wherein the back-end application computer server is further programmed to: (i) benchmark risk information against other entities, (ii) benchmark risk information against other enterprises, (iii) arrange for a user associated with an entity to logon and access the interactive user interface display, (iv) arrange for a user associated with an entity to modify the interactive user interface display, (v) allow for potential sub-relationships to be added to the interactive user interface display, (vi) allow for relationships with other enterprises to be added to the interactive user interface, (vii) provide an ability to process fictional data, (viii) and adjust at least one predictive model associated with total cost of risk.

16. The system of claim 1, wherein the back-end application computer server normalizes the historic resource values and calculates risk information in accordance with at least one of: (i) a periodic batch process, (ii) in response to a request, and (iii) in substantially real time.

17. A computerized method to provide an automated risk analysis tool via a back-end application computer server of an enterprise, comprising:
receiving, at the back-end application computer server, an indication of a selected risk relationship between the enterprise and a selected entity;
retrieving, by the back-end application computer server from the existing risk relationship data store, an electronic record associated with the selected risk relationship, including the set of historic resource values associated with risk attributes, wherein the existing risk relationship data store contains electronic records that represent a plurality of existing risk relationships between the enterprise and a plurality of users, and further wherein each electronic record includes an electronic record identifier and a set of historic resource values associated with risk attributes;
receiving an indication of a user selected revenue base for a most recent evaluation time period;
receiving a user selectable normalization parameter;
normalizing historic resource values based on the received user selectable normalization parameter;
outputting the normalized historic resource values via communication port; and
facilitating a transmission of data with a remote device to support a graphical interactive user interface display via a distributed communication network, the interactive user interface display including entity risk information calculated based on the normalized historic resource values.

18. The method of claim 17, wherein the risk relationships are associated with insurance policies and at least one historic resource value comprises a total cost of risk for the selected entity.

19. A non-tangible, computer-readable medium storing instructions, that, when executed by a processor, cause the processor to perform a method to provide an automated risk analysis tool via a back-end application computer server of an enterprise, the method comprising:
receiving, at the back-end application computer server, an indication of a selected risk relationship between the enterprise and a selected entity;
retrieving, by the back-end application computer server from the existing risk relationship data store, an electronic record associated with the selected risk relationship, including the set of historic resource values associated with risk attributes, wherein the existing risk relationship data store contains electronic records that represent a plurality of existing risk relationships between the enterprise and a plurality of users, and further wherein each electronic record includes an electronic record identifier and a set of historic resource values associated with risk attributes;
receiving an indication of a user selected revenue base for a most recent evaluation time period;
receiving a user selectable normalization parameter;
normalizing historic resource values based on the received user selectable normalization parameter;
outputting the normalized historic resource values via communication port; and
facilitating a transmission of data with a remote device to support a graphical interactive user interface display via a distributed communication network, the interactive user interface display including entity risk information calculated based on the normalized historic resource values.

20. The medium of claim 19, wherein the risk relationships are associated with insurance policies, at least one historic resource value comprises a total cost of risk for the selected entity, and the user selectable normalization parameter is associated with at least one of: (i) a number of employees, (ii) an amount of revenue, and (iii) a quantity of product.
